(19) United States
(12) Patent Application Publication
(10) Pub. No.: US 2013/0316837 A1
(43) Pub. Date: Nov. 28, 2013

(54) FOOTBALL PLAY SELECTION APPLICATIONS

(71) Applicant: Charles Edward Coiner, JR., Austin, TX (US)

(72) Inventor: Charles Edward Coiner, JR., Austin, TX (US)

(21) Appl. No.: 13/956,116

(22) Filed: Jul. 31, 2013

Related U.S. Application Data
(63) Continuation-in-part of application No. 13/758,862, filed on Feb. 4, 2013.
(60) Provisional application No. 61/594,738, filed on Feb. 3, 2012.

(51) Int. Cl. G07F 17/38

(52) U.S. Cl. CPC G07F 17/38
USPC 463/43

(57) ABSTRACT

A play selection method, server, and media includes presenting a sequence of play selection interfaces to a user, wherein at least some of the play selection interfaces include a plurality of diagrams, receiving user inputs selecting one of the diagrams from each of the play selection interfaces, and determining a selected play, based on the user inputs, from a plurality of plays in a play database. The play database may associated with a team and the plurality of diagrams included in a play selection interface may be selected based on historical play information indicative of plays executed by the team. At least some of the play selection interfaces may be associated with a corresponding play characteristic. In at least one embodiment, the play selection interfaces include an offense/defense interface, a run/pass/kick interface, a formation interface, a protection interface, a route concept interface, and a game situation interface.

### CROSS REFERENCE TO RELATED APPLICATIONS

This application is a continuation in part of U.S. patent application Ser. No. 13/758,862, entitled “ELECTRONIC FOOTBALL PLAYBOOK” filed Feb. 4, 2013, which claims priority from U.S. Provisional Patent Application No. 61/594,738, filed Feb. 3, 2012, entitled “PLAYBOOK MOBILE APPLICATION”, both of which are incorporated by reference herein in their entirety.

### BACKGROUND

1. Field

The present disclosure relates to the sport of North American football and, more specifically, electronic databases containing information relevant to football.

2. Background

North American football is an athletic game characterized by a sequence of distinct plays, each of which begins when movement of the ball is initiated by the team in possession of the ball and each of which has a distinct ending. Between plays, the players on the field for each team may huddle to identify the next play that the team will execute. In this context, a play refers to a predetermined set of one or more tasks or assignments for each player on the team. At the most general level, a team will execute three categories of plays, namely, offense, defense, and special teams, sometimes referred to as kicking plays. Of these three categories, the offense category is the category that includes the most variation and is often the category that is most often associated with the concept of play calling. Although there was a time in the history of football when offensive play calling may have been delegated to the team's quarterback, play calling is generally the responsibility of one or more coaches, usually the team's head coach or offensive coordinator.

Those who are involved with the game (e.g., coaches, players, personnel departments) strive to adopt a playing style that is best suited for their team. Historically, this has been accomplished by studying playbooks, video, attending clinics, and reading books authored by coaches who have had previous success in a particular system of plays. The plays may then be organized in a playbook, from which the coaches choose plays that fit the personnel and philosophy of their football team.

In practice, the plays are chosen from different systems using different vocabularies. Once the plays are chosen, the coaches adopt or create a vocabulary to identify the plays that may be unique to their football team. Using this vocabulary, the coaches may organize a group of plays into a playbook, a hardcopy or electronic collection of static images of plays. However, as the complexity of the game has evolved, the limitations of hardcopy playbooks have become more pronounced. Just as a few examples, coaches using a simple playbook often find it difficult to locate plays they have used previously. More generally, accessing a particular play at any point in time is difficult with a conventional playbook. The playbook may also provide limited support of searching for plays using relevant criteria, which can be a significant challenge when a large number of plays are being managed. Moreover, football is a game that requires multiple assistant coaches communicating with a head coach and issues of access, distribution, and coherency arise with hardcopy playbooks. In addition, as the popularity of football has increased and consumer electronics and technology have evolved, opportunities for interactive consumer involvement with the game have arisen.

### BRIEF DESCRIPTION OF THE DRAWINGS

FIG. 1 and FIG. 1B illustrates a playbook system;

FIG. 2 illustrates a mobile device in communication with a playbook database;

FIG. 3 illustrates a play selection method;

FIG. 4A, FIG. 4B, and FIG. 4C illustrate user interfaces for selecting one or more plays from an electronic database of plays;

FIG. 5A, FIG. 5B, and FIG. 5C illustrate additional user interfaces for selecting one or more plays from an electronic database of plays;

FIG. 6A, FIG. 6B, and FIG. 6C illustrate additional user interfaces for selecting one or more plays from an electronic database of plays;

FIG. 7 illustrates a play selection method emphasizing a feature targeted for coaches and players;

FIG. 8A and FIG. 8B illustrate play selection user interfaces suitable for use with the method illustrated in FIG. 7;

FIG. 9A, FIG. 9B, and FIG. 9C illustrate additional play selection user interfaces suitable for use with the method illustrated in FIG. 7;

FIG. 10A, FIG. 10B, and FIG. 10C illustrate additional play selection user interfaces suitable for use with the method illustrated in FIG. 7;

FIG. 11 illustrates a play selection method emphasizing a fantasy feature targeted for consumers and home users;

FIG. 12A, FIG. 12B, and FIG. 12C illustrate play selection user interfaces suitable for use with the method illustrated in FIG. 11;

FIG. 13A, FIG. 13B, and FIG. 13C illustrate additional play selection user interfaces suitable for use with the method illustrated in FIG. 11;

FIG. 14 illustrates additional play selection user interfaces suitable for use with the method illustrated in FIG. 11; and

FIG. 15A, FIG. 15B, and FIG. 15C illustrate a collection of exemplary plays.

### DESCRIPTION OF THE EMBODIMENT(S)

North American football involves two teams playing against each other in an offensive and defensive formation. The game involves individual plays from a line of scrimmage where the football is placed based on results of a previous play. For each game, coaches and players may come up with a plan to achieve their objectives, including developing a playbook for planning specific actions and strategies during the game. In Table 1 below, terminology that shall be used herein regarding plays is defined.

TABLE 1
Terminology for Plays

| TERM | DEFINITION |
|---|---|
| formation | an initial location of players at the beginning of |
| | a play |
| play | depending on the context, a play shall refer to: |
| | 1) an actual unit of a football game performed |
| | by the players; or |
| | 2) information or data indicating the |
| | combination of a formation and one or more |
| | routes assigned to one or more positions, and |
| | may be electronic or tangible |
| play image | a graphical representation of a play, illustrating |
| | a formation and one or more routes for one or |
| | more positions |
| playbook | a collection of plays, whether electronic or |
| | tangible |
| player | an individual assigned to any of the positions |
| position | a position indicates an initial location for one |
| | of the players and suggests a set of routes that |
| | the indicated player may have to perform |
| route, position-route | a path of travel, assigned to a position for a |
| | specified play, that the player assigned to the |
| | position is expected to execute during the play |
| point of scrimmage | location of the ball at the beginning of a play, |
| | also defines a line of scrimmage |

An electronic playbook may be in the form of an application for managing plays and may include features for creating and filtering plays based on factors such as the formation used and the routes assigned to one or more positions. In certain embodiments, the application may be used on a tablet, a smart phone, or another suitable mobile device and may communicate with a database of plays referred to herein as a playbook database. The application may also be used on a laptop, notebook, desktop, server, or other computer system that is either mobile or stationary. The playbook database may be located on a remote server or locally and may include various types of data related to plays, as will be described in further detail herein. The plays in the database may include a standard set of “stock” plays and may be customized to include plays specific to coach or team. Ownership of the playbook database is an implementation detail and the playbook application can interact with any playbook database that has a compliant informational structure.

In some implementations, the application enables a user to identify, select, or otherwise access plays in the playbook database via a query including, as examples, a concept query, a combination query, or a route query. The query may be executed by the application in response to user input at the application interface. Based on the database query, the application interface may enable the user to identify and view one or more plays according to various criteria. For example, the concept query and the combination query may represent predefined search criteria for implementing higher level access to the playbook database that allows the user to focus on a given position-route, a tactical responsibility for one or more position(s), or a strategic objective of position-routes for a given play.

In addition to the ability to identify existing plays in the playbook database, at least one embodiment of the playbook application enables the user to design a new play and add it to the database. For example, a user may select a formation and associate the formation with a new combination of one or more routes to be executed by one or more receivers to create a new play, which may then be added to the playbook database.

In some embodiments, the application may enable selection of the concept query using a touch interface and a displayed concept button and may allow the user to intuitively choose and view plays conceptually organized by strategies commonly applied to the game of football. In some embodiments, the application may enable selection of the combination query using a touch interface and a displayed half-field combo button and may allow the user to intuitively choose and view plays organized by route combinations for two or more players on one side of the formation. In some embodiments, the application may enable selection of the route query using a touch interface and a displayed any-route button and may enable selection of plays based on formation and the individual routes of one or more positions (i.e., receivers) by presenting the user with touch-selectable display screens for selecting a formation, a designated receiver or other position in the formation, and a particular route or responsibility that the designated position may have in the selected formation.

The application may further enable the user to identify, name, rename, group, edit, and/or save plays to a playbook that may be created, maintained, and/or distributed by the user, for example, to a team of additional users. In this manner, the application may allow a user to create playbooks for specific game circumstances. The application may support the distribution, by email or otherwise, of plays and playbooks to other users. Playbooks may include attributes for defining specific categories of players based on age, ability, or other factors, specific down and distance situations, specific opponents, specific weather conditions, and so forth. The application may also provide access to video associated with specific plays, which may be a desired convenience for coaches and players. In one embodiment, the route query may be used to integrate with video to enable the user to find plays intuitively. In some embodiments, the user may choose a route using the any-route button and watch video clips of some or all plays that include a specific route for a specific position.

Although the specific examples presented herein for descriptive clarity depict pass game plays in offensive football, the application may be used to specify formations and position-routes for various game plays. The application may be used for various aspects of offensive football including the run game, play action pass game, as well as situational football including red zone plays, third down plays, short yardage plays and goal line plays. The application may be used for defensive football including finding defenses by fronts, front adjustments, stunts, dogs, blitzes, and secondary coverages. The application may be used for special teams including punt, punt return, kickoff, kickoff return, point after attempts and field goals, point after attempt blocks and field goal blocks.

In one aspect, a disclosed method for accessing plays may include receiving user input indicating a search criteria, identifying, from a database, plays matching the search criteria, and enabling a user to select the plays matching the search criteria. The search criteria may specify at least one of: a formation and a position-route.

In certain embodiments, the database may store formation data for the formation, while the formation includes location data for each of a plurality of positions in the formation, and position data for each of the plurality of positions. The location data may specify a start location, relative to a point of scrimmage, in the formation, while the position data may specify a position identifier for a position in the formation. The database may store position-route data for the position-route. The position-route data may specify a designated route for a designated position in the formation, the designated route originating from the start location for the designated position. The method operation of enabling the user to select the plays may include generating a play image for a first play matching the search criteria. The play image may represent formation data and position-route data associated with the first play. The method operation of generating the play image for the first play may include at least one of retrieving at least a portion of the play image from the database, and rendering the play image using the formation data and the position-route data. The search criteria may specify the position-route, wherein the user input comprises a user-defined route for a position. The user-defined route may be received as a touch input from the user. The method may further include enabling the user to selectively access portions of a video matching the search criteria.

In particular embodiments, the method may include enabling the user to create a playbook, including specifying a playbook identifier for the playbook, and enabling the user to access the playbook. Accessing the playbook may include at least one of accessing the playbook using the playbook identifier, adding a play to the playbook, deleting a play from the playbook, and modifying metadata associated with a play in the playbook.

In another aspect, a disclosed database system for retrieving plays. The database may include a processor configured to access memory media, and a database of plays, including formation data and position-route data for each play stored in the database. The memory media may include instructions executable by the processor. The instructions, when executed by the processor, may cause the processor to perform operations including receiving a search criteria describing plays, issuing a query to the database for plays matching the search criteria, and outputting the plays resulting from the query. The search criteria may specify at least one of a formation and a position-route.

In certain embodiments, the memory media may include instructions for receiving play data describing a new play, and adding the play data received to the database. The play data may include formation data and position-route data for the new play. The database accommodates, for each play, metadata selected from a concept identifier describing a general football concept, a combination identifier describing position-route data for at least two positions, a play identifier, a playbook identifier, a formation identifier, a plurality of player data identifiers, a video identifier, and position-route identifiers for each of a plurality of positions. The search criteria include at least one of the concept identifier and the combination identifier.

In yet another aspect, transitory computer readable memory media may store executable instructions to receive user input indicating a search criteria, retrieve, from a database, plays matching the search criteria, and enable a user to select the plays matching the search criteria. The search criteria may specify at least one of a formation and a position-route.

In the following description, details are set forth by way of example to facilitate discussion of the disclosed subject matter. It should be apparent to a person of ordinary skill in the field, however, that the disclosed embodiments are exemplary and not exhaustive of all possible embodiments.

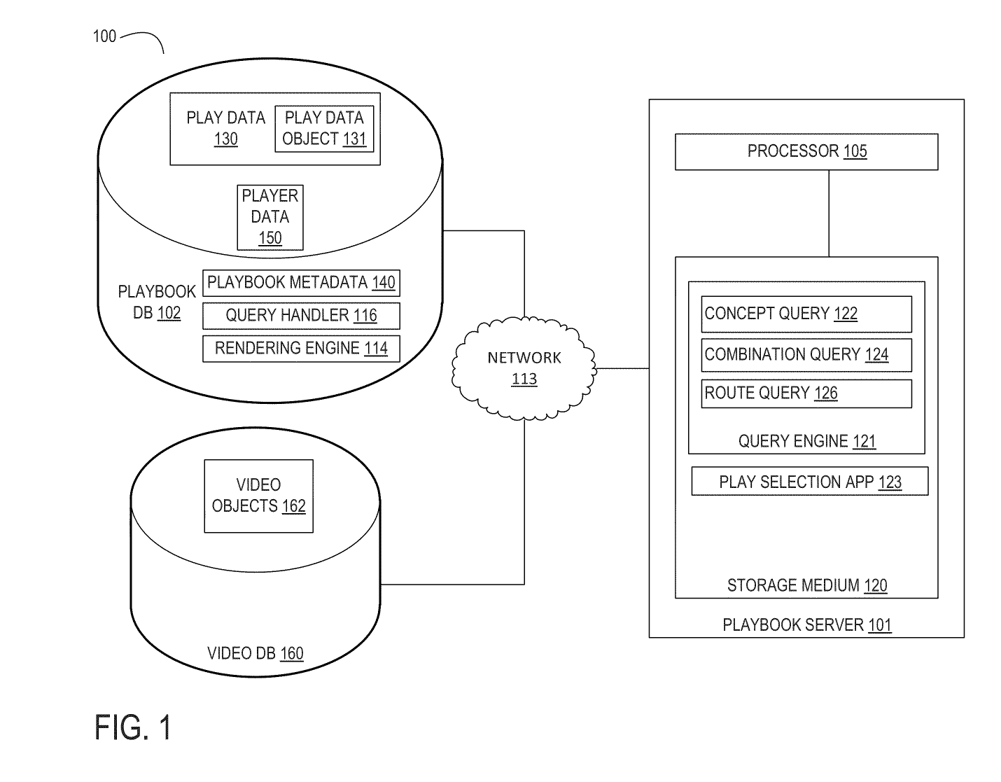

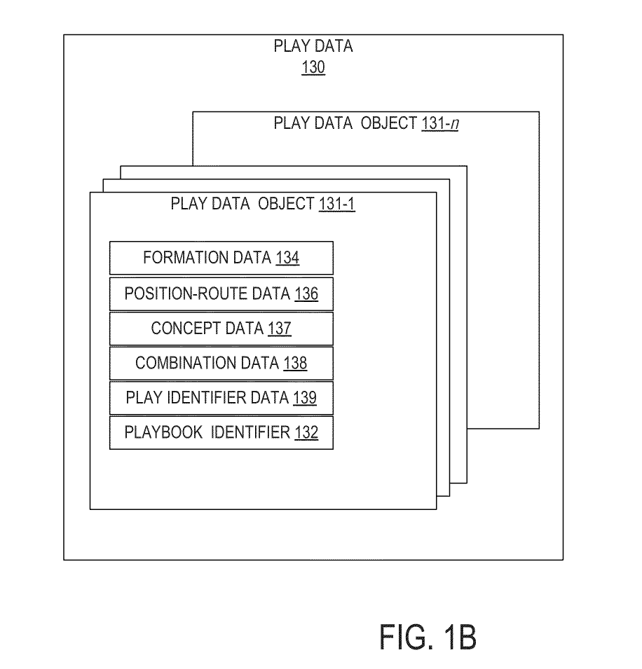

Turning now to the drawings, FIG. 1 is a block diagram of selected elements of playbook system 100, which may also be referred to herein simply as playbook system 100. In at least one embodiment, playbook system 100 may be used to identify, select, access, review, and modify one or more plays from a database, referred to herein as playbook database 102 containing data, identified in FIG. 1 as play data 130 associated with a multitude of football plays. In at least one embodiment, playbook system 100 facilitates intuitive and efficient identification and selection of plays by combining drawings or illustrations that convey aspects of one or more plays with metadata that indicates a number of characteristics of a play. Play data 130 may define or characterize plays according to a number of predetermined parameters and a characteristic of a play may be associated with a particular value of a play parameter. Playbook database 102 may characterize some or all of the plays in play data 130 with respect to a number of parameters and the particular values associated with each parameter may define a corresponding characteristic of the play. For example, playbook database 102 may include data indicative of a value for a formation parameter associated with some or all of the plays in play data 130. In at least one embodiment a value for a particular parameter defines a characteristic of the corresponding play. Continuing with the formation parameter example, a formation parameter value of “5” may indicate plays that are executed out of a particular shotgun formation. In at least one embodiment, playbook database 102 includes a data structure identified as playbook metadata 140 that defines the metadata associated with the applicable playbook database 102. Playbook metadata 140 may include information identifying the various parameters with which a play may be described and the various values of each parameter that the database supports.

Playbook system 100 may be used in conjunction with any number of play selection applications. These applications include, as examples, playbook creation, modification, customization, and distribution, game preparation including film study and game plan development, and consumer or home-user play selection applications including “fantasy” play selection applications. At least one embodiment of playbook system 100 incorporates figures illustrating various aspects of particular plays within play data 130. A play selection application 123 hosted or supported by playbook system 100 may access, generate, display, or otherwise provide a sequence of one or more user interfaces, including the figures, to a user. Depending upon the application, the user may be skilled in the field of football strategy, football terminology, and the design and analysis of football plays, e.g., a coach or player. In other applications, the user may be a consumer or home user who is relatively unsophisticated in football strategy. By organizing playbook database 102 according to a relatively small number of play selection parameters and associating parameters with corresponding user interfaces that include visual depictions associated with the corresponding parameter, at least one embodiment of playbook system 100 facilitates rapid, intuitive, and efficient play selection regardless of the user's sophistication. Moreover, playbook database 102 may include team specific data including, as examples, player data 150 and play history data, not expressly depicted in FIG. 1, that facilitate a customization or optimization of play selection application 123 in which the user interfaces that the application generates and provides to a user reflect any tendencies that the team exhibits.

The playbook system 100 illustrated in FIG. 1 includes a playbook server 101 in communication with a playbook database 102 via a network 113. The playbook server 101 illustrated in FIG. 1 includes a processor 105 and a storage device, memory, or other form of tangible, computer-readable storage medium 120 that includes processor executable program instructions including instructions associated with a play selection application 123 and instructions associated with a query engine 121. Whenever processor 105 executes instructions stored in storage medium 120, the instructions cause processor 105 to perform operations including operations described herein.

The playbook system illustrated in FIG. 1 includes, in addition to playbook database 102, video database 160, also accessible to playbook server 101 via network 113. The video database 160 illustrated in FIG. 1 includes video objects 162. In some embodiments, video objects 162 correspond to a single play in a football game or practice. The play featured in a video object 162 may be associated with a coach's or player's own team or with another team such as an upcoming opponent. The video objects 162 may be tagged or otherwise associated with metadata characterizing the applicable play. In embodiments compatible with play selection application 123, for example, the video objects 162 in video database 160 may include metadata indicating values for the same parameters that play selection application 123 employs to identify plays. In these embodiments, play selection application 123 may be used in conjunction with pre-tagged video objects 162, to access film or other form of video content of a particular play or particular type of play and so forth.

In at least one embodiment, playbook database 101 is a database server or includes features and functionality of a database server to facilitate access to data stored in playbook database 102, including play data 130. Play data 130 may include a distinct play data object 131 pertaining to each unique play encompassed by a team or other football organization. Although the figures described herein emphasize offense, play data object 131, as is true with respect to other features of play selection application 123 and playbook system 100, encompass both defensive and special teams plays as well.

Referring to FIG. 1B, for example, play data 130 includes play data objects 131-1 through 131-n, each of the play data objects corresponding to one of n plays included within playbook database 102. Each play data object 131 may include values for a predetermined number of a play parameters that define a set of characteristics for the applicable play. With respect to play selection applications that present users with a sequence of one or more user interfaces, play data objects 131 may include data corresponding to each play selection parameter that a user must define or select. For example, if a play selection application requests users to select a formation, each play data object 131 may include data indicating the formation from which the play is executed. Play data objects 131 may include drawings or illustrations including formations and patterns executed by one or more players.

As depicted in FIG. 1B, each play data object 131 includes data corresponding to one or more parameters or characteristics of the play. The play data objects 131 depicted in FIG. 1B, for example, include formation data 134, corresponding to a formation parameter, which may illustrate or otherwise indicate initial location information for each position represented. Thus, formation data 134 may indicate the formation from which a play is executed. Accordingly, formation data 134 may include images, numerical data or a combination thereof conveying the starting position of each position. The start locations may be specified relative to an origin including, for example, a point of scrimmage representing a location from which the football will be snapped at the start of the next play. Thus, the location data may include 2-dimensional coordinates to specify start locations. Other origins may be arbitrarily used in different embodiments, such as a corner of a play image space. In some implementations, the formation refers more generally to the relative location of the players rather than a set of specific locations. For example, a 2-back formation may refer to any formation in which, as an example, the formation includes five offensive linemen, one wide receiver on one side of the formation, a second wide receiver and a tight end on the other side of the formation, a quarterback “under” center, and two running backs behind the quarter back, one on either side of the quarterback.

In addition to location data, formation data 134 may include position data for each player illustrated in the formation. The position data, represented as position-route data 136, in FIG. 1B, may specify a position identifier for a given position. The position identifier may be a character that appears in the position in a play image and may be specified by a user or an entity using playbook system 100. The location data and the position data may be used to generate and/or render the play image of a play for display to a user. It is noted that a number of positions (including location data for the positions, and position data for the positions) may vary in number and scope, as desired. In other words, formation data 134 may be usable to specify a full and/or a partial implementation of a formation. In various embodiments, formation data 134 may be used to specify a plurality of formations, which may be individually accessed using a formation identifier.

The play data objects 131 illustrated in FIG. 1B include position-route data 136, which may include data and/or illustrations indicating designated routes for one or more designated positions. Unless a play calls for pre-snap motion for one or more positions, designated routes generally originate from the formation location assigned to the applicable position. Position-route data 136 may include a number of designated routes that are specified for a given position. Position-route data 136 may include designated routes for a plurality of positions. The designated route may be specified relative to the start location and may include 2-dimensional path data (not shown) at a desired level of granularity or precision. In certain embodiments, position-route data 136 may include position-route identifiers for each of a plurality of positions, whereby the position-route identifiers are used to access path data for the route. In certain embodiments, position-route data 136 may be maintained and/or rendered in image form by playbook database 102.

As suggested previously, playbook metadata 140 may include information defining the parameters or characteristics of a play that a play selection application requires or considers in selecting or otherwise identifying or accessing plays in playbook database 102. In addition to the formation parameter and the position-route parameter explained above, playbook metadata 140 may include a formation identifier for each play, along with position-route identifiers specifying position-route data 136 for desired positions for the play. Playbook metadata 140 may define or include references to additional play parameters for each individual play stored in playbook database 102. The play data object 131 depicted in FIG. 1B includes concept data 137 for a concept parameter; combination data 138 for a combination parameter that describes position-route data for at least two positions, a play identifier data 139 uniquely identifying a play, a playbook identifier 132 uniquely identifying a playbook; a formation identifier uniquely identifying a formation; a plurality of player data identifiers describing attributes (or desired attributes) of individual athletes assigned to positions; a video identifier; and position-route identifiers for each of a plurality of positions. In this manner, playbook metadata 140 may enable playbook system 100 to provide users with the ability to search and/or browse plays stored in playbook database 102 according to various criteria and relevant attributes of individual plays, as will be described in further detail herein.

Also shown in FIG. 1B, playbook database 102 includes play data 130. Play data 130 may be usable to generate playbooks, or collections of individual plays. Users may use play data 130 to create and store playbooks, but also to distribute playbooks to other users. For example, a football coach may prepare a playbook for an upcoming game and distribute the playbook electronically to players on the coach's team. Thus, play data 130 may include a playbook identifier, along with a plurality of play identifiers, to describe collections of plays in a playbook. In other embodiments, play data 130 may include rendered play images that are suitable for viewing and/or printing.

Still referring to FIG. 1, playbook database 102 is shown including player data 150, which may describe attributes of individual athletes who assume roles in positions. Player data 150 may be used to specify certain attributes of an athlete for a given play. For example, an age of an athlete may be used to discriminate certain plays (or entire playbooks) that are physically unsuitable for younger players. In certain embodiments, player data 150 may include attributes describing certain abilities of an individual athlete, such as a jump height, for example, which may be used to specify certain types of players in a play. Thus, certain plays stored in playbook database 102 may be linked, for example, using playbook metadata 140, to player data 150 to filter or specify attributes of players in positions.

As shown in FIG. 1, playbook database 102 also includes rendering engine 114, video database 160, and query handler 116. Rendering engine 114 may generate images, such as play images, from other data stored in playbook database 102, as described above. The rendered play images may be displayed to a user and/or included in a playbook. Video database 160 may provide access to football video that may be accessed and played back to a coach, player, or other user. In at least one embodiment, video database 160 may include a plurality of football video objects or links to externally stored football video objects. In some embodiments, the video objects in video database 160 include videos of individual plays executed by a team in a previous game or practice or earlier in a current game or practice. The team executing the plays in the video objects may be the next opposing team a coach or player has to play against or the coach's or player's own team. The video objects in video database 160 may be tagged with metadata indicating information about the corresponding play including, in at least one embodiment, indications of values for parameters used by a play selection application. For example, a video of a play that is executed out of a specific formation may be tagged with metadata indicating that the play represented in the corresponding video is executed out of the specific formation. In these embodiments, the user inputs to select one or more plays may be the same or similar user inputs to identify one or more videos in video database 160. The playbook database 102 depicted in FIG. 1 includes playbook metadata 140, which may include information defining the meaning of metadata used to tag video objects 162. Although video database 160 is depicted as a part of playbook database 102, other embodiments may encompass implementations in which video database 160 is stored in a different database than playbook database 102 and accessed by a different server or system.

Query handler 116 may be a module within playbook database 102 that is capable of receiving queries and outputting results of the received queries. Examples of queries that may be received by playbook database 102 shown in FIG. 1 are concept query 122, combination query 124, and route query 126, as described previously.

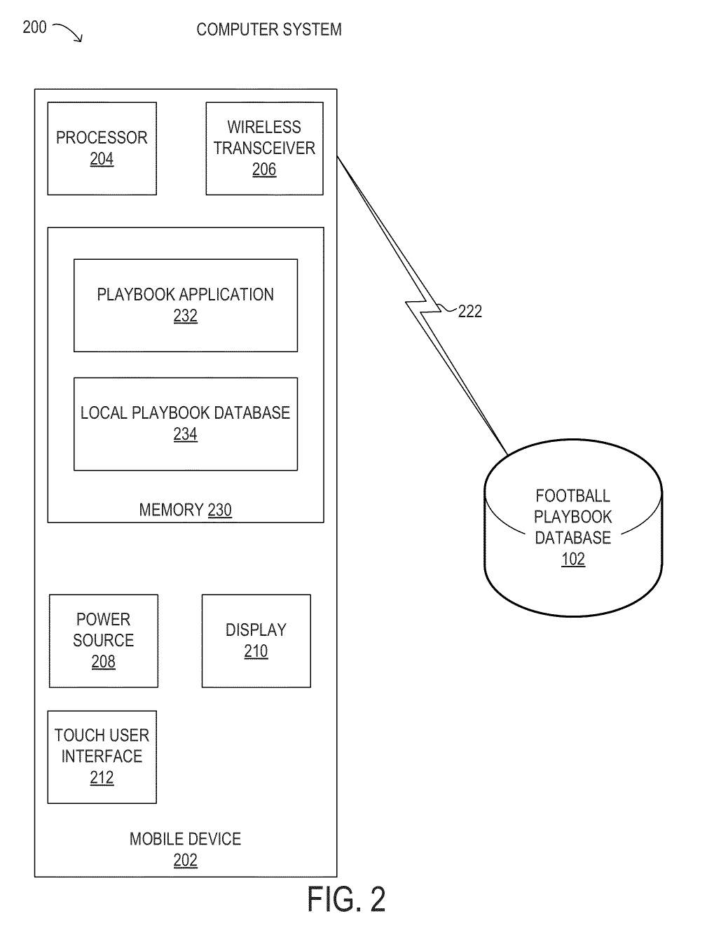

In operation, playbook system 100 may enable playbook database 102 to be populated with data and/or images representing plays. A user and/or a provider of playbook system 100 may populate playbook database 102 with plays. Once populated, a user may execute playbook application 232 (see FIG. 2) to access plays stored within playbook database 102. The access may include browsing or searching for individual plays using various criteria. For example, concept query 122 and combination query 124 may enable searching for plays based on high-level football concepts, while route query 126 may enable searching based on specific route paths for desired positions. The plays matching a received search criteria may be presented to the user as a collection of plays, which the user may view, browse, and/or select. Certain plays outputted to the user may be added to a playbook, which can be stored by the user and retrieved, for example, for distribution. Additionally, video segments of individual plays, when available, may be played back to a user of playbook application 232, and/or may be included with a playbook.

Referring now to FIG. 2, a block diagram of selected elements of an embodiment of computer system 200 is depicted. In computer system 200, mobile device 202 may represent a tablet, a smart phone, or another suitable mobile device and may communicate with playbook database 102 (see FIG. 1) via communication link 222, which may be a wireless link. In other embodiments (not shown) mobile device 202 may be replaced by a computer system, such as a personal computer, that is either mobile or stationary. As will be described below, certain contents of playbook database 102 may be located on a remote server or locally to mobile device 202 and may include various types of data related to plays, as mentioned previously.

In FIG. 2, processor 204 may represent at least one processing unit and may further include internal memory, such as a cache for storing processor executable instructions. In various embodiments, processor 204 is operable to perform operations associated with electronic playbooks, as described herein. Processor 204 may access memory 230 to receive executable instructions and/or to store data in memory 230.

In FIG. 2, wireless transceiver 206 may represent a communications transceiver providing an interface for any of a number of communication links. In certain embodiments, wireless transceiver 206 supports wireless communication links, such as infrared (IR), radio frequency (RF), and audio, among others. Examples of RF wireless links include the IEEE 802.xx family, such as WiFi® (IEEE 802.11) and Bluetooth® (IEEE 802.15.1). In addition to wireless transceiver 206, playbook database 102 may further support mechanically connected communication links, such as galvanically wired connections, sensor interface connections, connections to external antennas, network connections (i.e., Ethernet), etc. Wireless transceiver 206 may transform an instruction received from processor 204 into a signal sent via communication link 222. It is noted that wireless transceiver 206 may be a bidirectional interface, such that responses, such as commands, information, or acknowledgements, may be received via communication link 222.

In FIG. 2, mobile device 202 may represent a tablet, a smart phone, or another suitable mobile device with application processing capacity. Mobile device 202 may be in the possession of a coach or other team official charged with planning and execution of plays in a football game. It is noted that an application executing on mobile device 202 may specifically be configured to operate with one or more instances of playbook database 102. Wireless transceiver 206 may further represent a client device in a wireless network (not shown) that is accessible via communication link 222. The wireless network may be a wide-area wireless network, such as a cellular telephony network, for example, and may enable mobile device 202 to communicate with playbook database 102 to exchange application data, commands, and data, as desired.

In FIG. 2, memory 230 encompasses persistent and volatile media, fixed and removable media, magnetic and semiconductor media, or a combination thereof. Memory 230 is operable to store instructions, data, or both. Memory 230 as shown includes data, which may be in the form of sets or sequences of executable instructions, namely, playbook application 232 and local playbook database 234. Playbook application 232 may include processor executable instructions to enable access to electronic plays, as described herein. Local playbook database 234 may represent a local cache of at least a portion of playbook database 102 that may enable mobile device 202 to operate partially or completely independently. For example, local playbook database 234 may enable a user to continue using playbook application 232 even when communication link 222 (or another network link) is unavailable, and may automatically synchronize with playbook database 102 when communication link 222 becomes available.

Also shown included with mobile device 202 in FIG. 2 is power source 208, which may represent a local power source, such as a battery and/or an interface to an external power supply. Power source 208 may be configured for DC, AC or both, and may be configured to convert between various levels of AC and/or DC power. Power source 208 may be configured to regulate an output voltage or an output current, as desired. Mobile device 202 is shown in FIG. 2 including display 210, which may be implemented as a liquid crystal display screen, a light-emitting diode (LED) screen, a computer monitor, a television or the like. Display 210 may comply with a display standard for the corresponding type of display. Standards for computer monitors include analog standards such as video graphics array (VGA), extended graphics array (XGA), etc., or digital standards such as digital visual interface (DVI), and high definition multimedia interface (HDMI), among others. A television display may comply with standards such as National Television System Committee (NTSC), Phase Alternating Line (PAL), or another suitable standard. In conjunction with display 210, touch user interface 212 may enable tactile input to content presented by display 210. In some embodiments, the user may choose a position that is an eligible receiver. The user may touch and drag their finger on touch user interface 212 as if to draw an image of a desired route for that receiver. Mobile device 202 may capture the touch-generated image and search playbook database 102 for a route most similar to the image drawn by the user. The user could draw an image for one eligible receiver or for a plurality of eligible receivers. Mobile device 202 may display all plays from playbook database 102 that matched the criteria provided by the user.

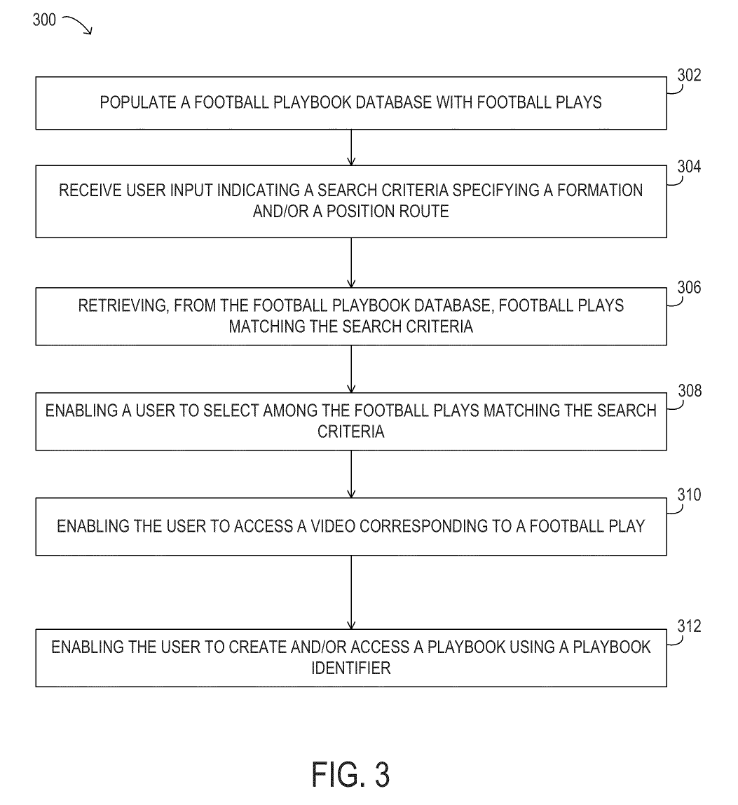

Turning now to FIG. 3, a block diagram of selected elements of an embodiment of method 300 for using an electronic playbook is depicted in flow-chart form. Method 300 may be performed using playbook database 102 and/or playbook application 232 (see FIGS. 1 and 2) in various embodiments. It is noted that certain operations described in method 300 may be optional or may be rearranged in different embodiments.

Method 300 may begin by populating (operation 302) a playbook database with plays. User input may be received (operation 304) indicating a search criteria specifying a formation and/or a position-route. Plays matching the search criteria may be retrieved (operation 306) from the playbook database. A user may be enabled (operation 308) to select among the plays matching the search criteria. The user may be enabled to access (operation 310) a video corresponding to a play. The user may be enabled to create and/or access (operation 312) a playbook using a playbook identifier. In the embodiment depicted in FIG. 3, two or more users may be able to share access to a common set of plays, i.e., a common playbook database or a common playbook created by one of the users. For example, an offensive coordinator may access the active playbook for a team's upcoming game and add an offensive play to the playbook. The offensive coordinator might then save the revised playbook back to the playbook database and make it or keep it accessible to the all coaches and players, coaches and players with a need to know, and so forth.

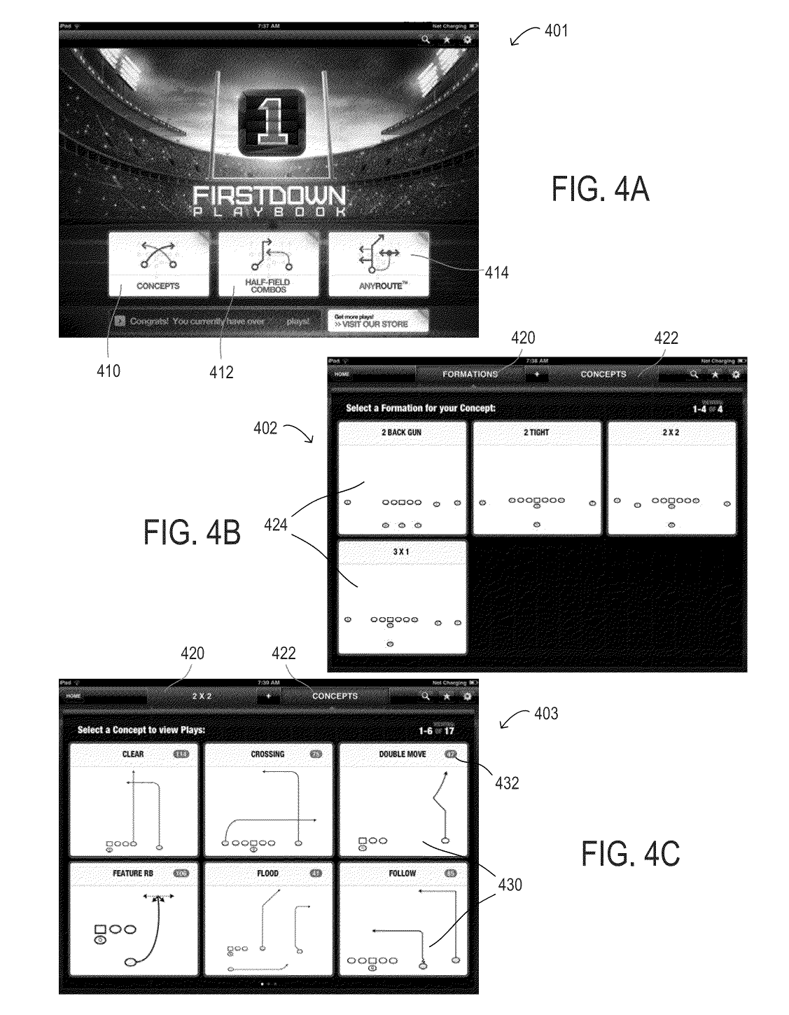

Turning now to FIGS. 4A, 4B, and 4C, display screens depicting selected elements of an embodiment of football playbook application 232 (see FIG. 2) are depicted. In FIGS. 4A-C, various user interfaces for performing a search query using football playbook application 232 are depicted. In FIG. 4A, user interface 401 may be a launch screen for selecting “CONCEPTS”, “HALF-FIELD COMBOS”, and “ANYROUTE™”, which correspond respectively to concept query 122, combination query 124, and route query 126, as discussed above with respect to FIG. 1. Specifically, button 410 may select “CONCEPTS”, button 412 may select “HALF-FIELD COMBOS”, and button 414 may select “ANYROUTE™”. In FIG. 4B, after selecting button 410 for “CONCEPTS” in user interface 401 (see FIG. 4A), user interface 402 may appear showing formations 424 that are presented as various play images for selection. Also shown in user interface 402 are formation display 420, which may show a current state of a formation selection, as well as detail display 422, which may show another current selection. In FIG. 4C, after selecting a formation called “2×2” in FIG. 4B, various concepts corresponding to the formation are presented as diagrams or panels 430 showing play images for selection in user interface 403. As shown, panels 430 each include play number indicator 432 showing a number of available plays (i.e., plays in the database matching the selected search criteria) for each respective instance of panels 430. In user interface 403, formation display 420 shows “2×2” as the selected formation, while detail display 422 shows “CONCEPTS”.

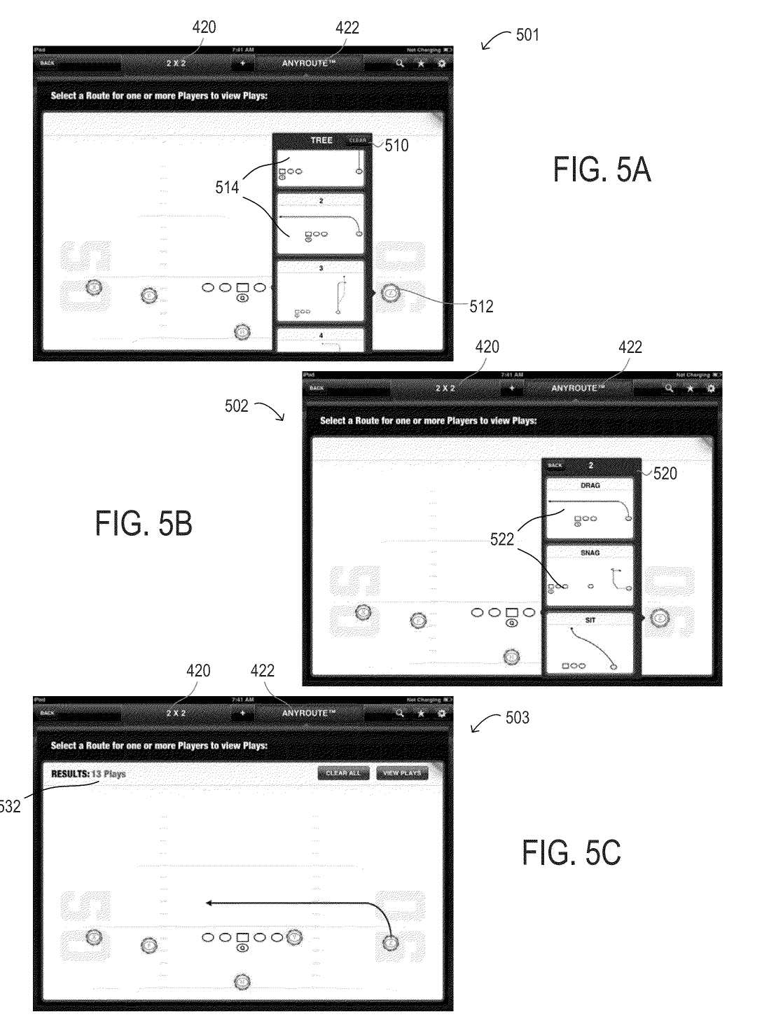

Turning now to FIGS. 5A, 5B, and 5C, display screens depicting selected elements of an embodiment of football playbook application 232 (see FIG. 2) are depicted. In FIGS. 5A-C, various user interfaces for selecting football plays retrieved using football playbook application 232 are depicted. The play images in FIG. 5A may represent families of similar plays that may be presented after selection of button 414 “ANYROUTE™” in user interface 402 (see FIG. 4A) and selection of a formation, which in user interface 501 is a “2×2” formation. Accordingly, in user interface 501, formation display 420 shows “2×2” while detail display 422 shows “ANYROUTE™”. In FIG. 5A, user interface 501 may show tree 510 of plays that are presented as play images for selection. Specifically, tree 510 may include play images of route types 514 that may be selected. Additionally, a team position for restricting position-routes may be selected, which in panel 501 is a “Z” receiver shown by indicator 512.

In FIG. 5B, after selecting route type 514 corresponding to “2” from tree 510 in user interface 501 (see FIG. 5A), tree 520 in user interface 502 may show routes 522 corresponding to route type 514 selected previously. For example, tree 520 may show a number of plays corresponding to a set of “2” routes that “Z” can run from a “2×2” formation for browsing and/or selection. In user interface 502 formation display 420 shows “2×2” while detail display 422 shows “ANYROUTE™”. In FIG. 5C, user interface 503 shows a selected play image representing the selected play from user interface 502 (see FIG. 5B). In response to a user selecting “2 drag” from routes 522 (see FIG. 5B), a first of 13 plays satisfying the previously selected criteria for formation, position, and route is shown in user interface 503, which includes indicator 532 showing the number of available plays. In user interface 503 formation display 420 shows “2×2” while detail display 422 shows “ANYROUTE™”. While not depicted, the user can then browse through the set of 13 plays that satisfy the “ANYROUTE™” criteria, viewing each individual play as desired.

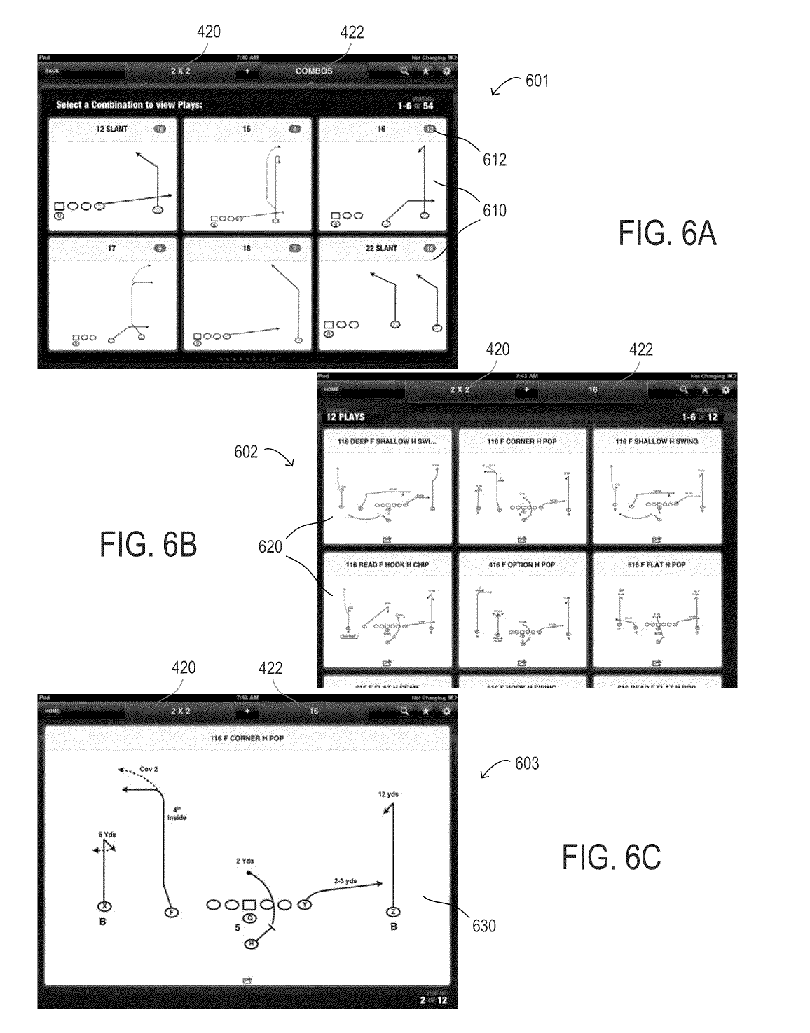

Turning now to FIGS. 6A, 6B, and 6C, display screens depicting selected elements of an embodiment of football playbook application 232 (see FIG. 2) are depicted. In FIGS. 6A-C, various user interfaces for selecting football plays retrieved using football playbook application 232 are depicted. In FIG. 6A, user interface 601 shows play families corresponding to search criteria presented as play images for selection. In FIG. 6A, user interface 601 may show panels 610 representing combinations that are available for selection after choosing button 412 (“HALF-FIELD COMBOS”, see FIG. 4A) and selecting “2×2” from formations 424 in user interface 402 (see FIG. 4B). Accordingly, in user interface 601 formation display 420 shows “2×2” while detail display 422 shows “COMBOS”. In user interface 601, each panel 610 may include indicator 612 showing a number of plays available for an individual combination. In user interface 601, play images in panels 610 may represent families of similar plays that may be presented for selection.

In FIG. 6B, user interface 602 shows panels 620 of individual plays presented after selection of a combination in user interface 601 (see FIG. 6A). In user interface 602, after selecting “16” from panels 610 (see FIG. 6A), panels 620 of play images of individual plays corresponding to a set of “16” combinations for a “2×2” formation are shown for browsing and/or selection. Accordingly, in user interface 602, formation display 420 shows “2×2” while detail display 422 shows “16”. In FIG. 6C, user interface 603 shows play image 630 representing a selected play from panels 620. In response to a user selecting “116 F CORNER H POP” from panel 602 (see FIG. 6B), play image 630 of the selected play is displayed in user interface 603. In user interface 603, formation display 420 shows “2 X 2” while detail display 422 shows “16”. It is noted that the user may rename (not shown) the play represented by the play image in FIG. 6C and may create (not shown) a playbook including the play, add (not shown) the play to an existing playbook, and rename (not shown) a playbook.

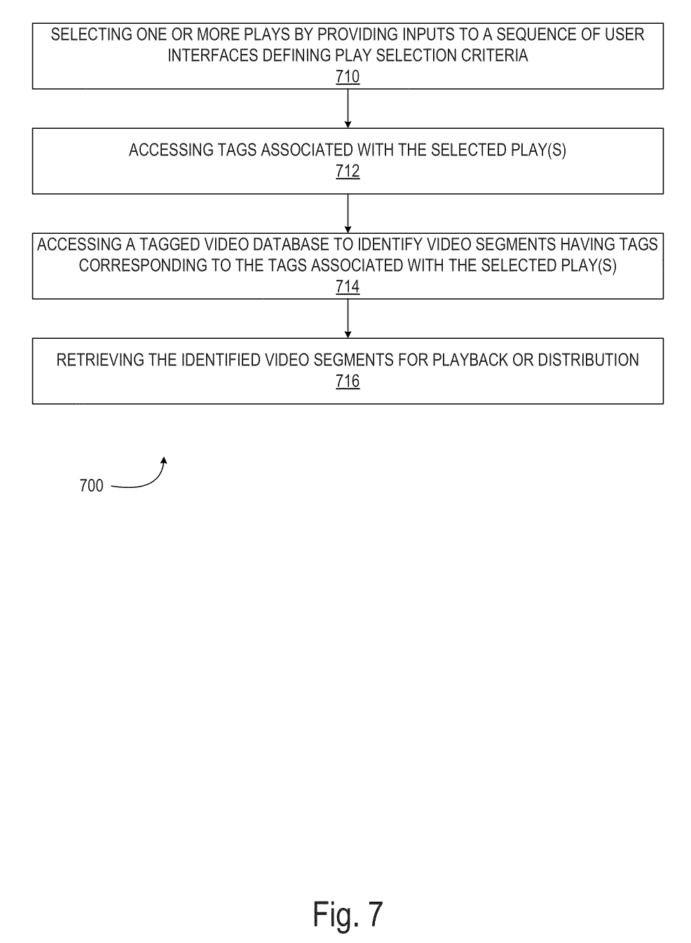

Now turning to FIG. 7, selected elements of an embodiment of method 700 for selecting one or more plays from an electronic database of plays are illustrated. In some embodiments, method 700 is employed to identify portions of football video that is of interest to a coach or player in assessing any tendencies, strengths, and weaknesses of the team or its opponents. Reviewing large quantities of video in preparation for an upcoming game, generally referred to as film study, is common practice in modern professional, collegiate, and high school football. The illustrated embodiment of method 700 includes selecting (operation 710) plays by providing inputs to a sequence of user interfaces defining play selection criteria. In some embodiments, the sequence of user interfaces defines plays with increasing specificity. For example, the user interfaces presented to the user may include a first interface that identifies a phase of the game, e.g., offense, defense, and kicking, while a later user interface may define the specific patterns or routes that eligible receivers take in the case of an offensive pass play.

After identifying one or more plays of interest, some embodiments of method 700 may then access (operation 712) tags associated with the selected play(s). The tags may identify individual plays according to a predetermined scheme or naming convention. For example, any given play may be tagged with a name uniquely identifying the play. The tag may, in another embodiment, include a concatenation or combination of the selection criteria used to identify the play. In still other embodiments, the tag may include a numerical value uniquely identifying the play. The tag may include a vector or combination of tag parts including tags for different characteristics of the play. For example, if the selected play is a pass play, a tag for the selected play may include a phase component having a value associated with a pass play.

The depicted embodiment of method 700 further includes accessing (operation 714) a tagged video database to identify video segments having tags corresponding to the tags associated with the selected play(s). In some embodiments, large quantities of video have been previously viewed and tagged. In some embodiments, the tagging of video may include the use of a play identification application that functions in a manner analogous to the play selection applications disclosed herein except that the user interfaces presented to the user are used to assign a video segment to a particular play and to tag the video segment accordingly. In some embodiments, the tagging of the video may be performed apart from the operations of method 700. In some embodiments, the video database is maintained separately from the playbook database and the tagging of video may be performed by a different user or entity than the coach, player, or other entity using method 700. While a video database, pretagged by a third party, may be a common implementation, other implementations may include video tagging as a step or operation of method 700. The depicted embodiment of method 700 further includes retrieving (operation 716) the identified video segments for playback or distribution. Retrieving video segments may include generating a list of video segments identified in operation 714.

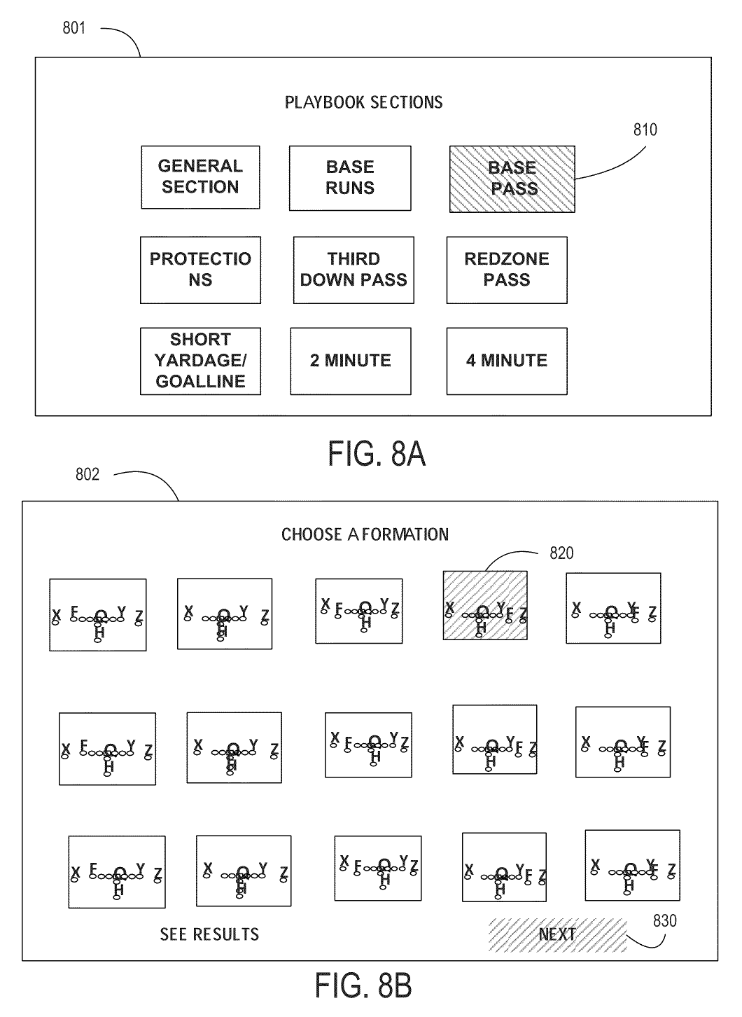

Turning now to FIG. 8A and FIG. 8B, display screens illustrating selected user interfaces of an embodiment of football playbook application 232 (see FIG. 2) are depicted. The user interfaces illustrated in FIG. 8A and FIG. 8B are exemplary of user interfaces used by coaches or players for selecting football plays. While the user interfaces illustrated in FIG. 8A and FIG. 8B emphasize offense, football playbook application 232 encompasses user interfaces for defense and special teams as well.

FIG. 8A illustrates a playbook section user interface 801 as one of a series of user interfaces presented to a user to select one or more plays. In some embodiments, each user interface corresponds to a play selection parameter and the user input provided in response indicates the value of the play selection parameter. The illustrated user interface 801 offers the user a choice of nine values for the playbook section parameter. The playbook section parameter classifies plays according to various situations in which the applicable plays might be most suitable. Selecting the short yardage option, for example, accesses plays that might be chosen when the offense needs two or less yards to cross the opponent's goal line or make a first down. The other playbook section options apply to other portions of the interface.

When the user indicates a selection from the user interface, the selection may be temporarily highlighted as the application advances to the next user interface. In FIG. 8A, a user has selected the “base pass” option 810, as suggested by the highlighting of the applicable option icon. While FIG. 8A depicts a “base pass” game parameter as being selected, any of the playbook section interface parameters may be selected.

FIG. 8B illustrates user interface 802 corresponding to a formation parameter. The illustrated user interface 802 includes 15 icons corresponding to 15 different formations that a user is able to select. In at least one embodiment, the formation parameter user interface 802 is presented following the selection of an icon from the preceding user interface. As illustrated in FIG. 8A and FIG. 8B, for example, user interface 802 may be presented to the user following the user's selection of a playbook section icon from user interface 801. In addition, the formation user interface 802 illustrates the base formation of the set of plays that satisfy the playbook section criteria. As illustrated in FIG. 8A and 8B, for example, the formation icons that populate formation user interface 802 include the formations of plays that are encompassed within the base pass plays selected with respect to playbook section 801. In some embodiments, the play selection process proceeds in this manner, with the application presenting user interfaces corresponding to each playbook database parameter and the user indicating a selection from the one or more available options to narrow the number of plays to one or more plays that satisfy all of the selected options. The FIG. 8B illustration is of user interface 802 with a particular formation 820 selected. The user interface 802 illustrated in FIG. 8B includes a “next” icon 830 that, when selected or otherwise indicated by the user, proceeds to the next user interface.

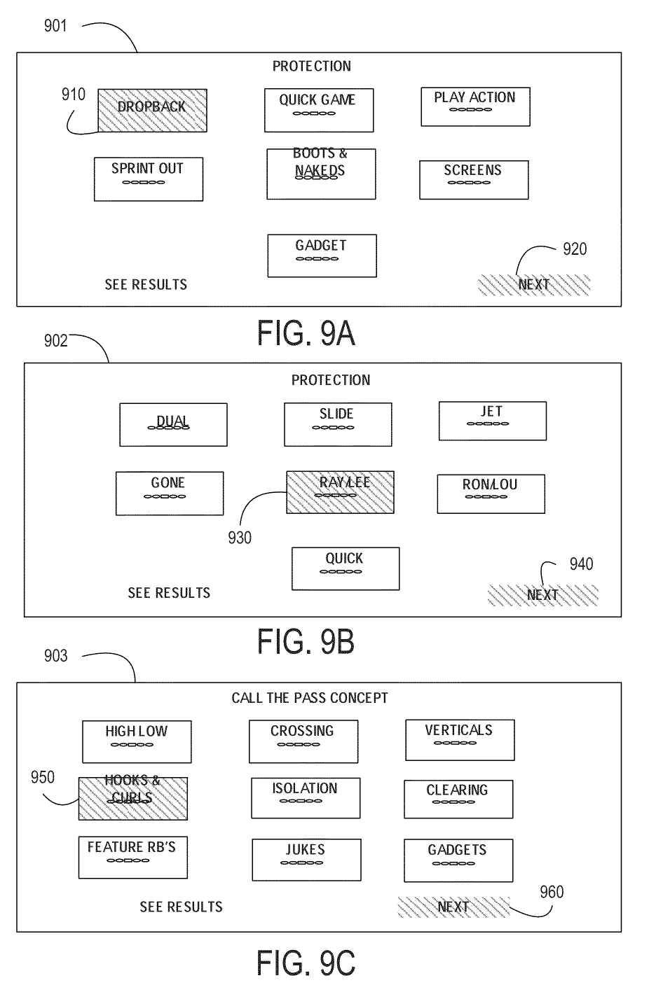

FIG. 9A and FIG. 9B illustrate exemplary user interfaces 901 and 902 for a “protection” parameter to illustrate an example in which the number of options for a play selection parameter is presented over multiple user interfaces. In this case, the “next” icon 920 on user interface 901 transitions the user from a first “protection” user interface 901 to a second “protection” user interface 902. The protection parameter further classifies plays according to a particular one of several available protection options. User interface 901 is illustrated in FIG. 9A with a “dropback” option 910 and a next icon 920 selected. User interface 902 is then illustrated in FIG. 9B with a “Ray/Lee” option 930 and an next icon 940 selected. In this case, the “next” icon 940 on user interface 902 transitions the user from a second “protection” user interface 902 to a “concept” play selection parameter user interface 903.

FIG. 9C illustrates a user interface 903 corresponding to a “concept” play selection parameter where the concept refers to one of several available choices for combinations of routes executed by a combination of two or more eligible receivers. User interface 903 is illustrated in FIG. 9C with a “hook and curl” option 950 and a next icon 960 selected.

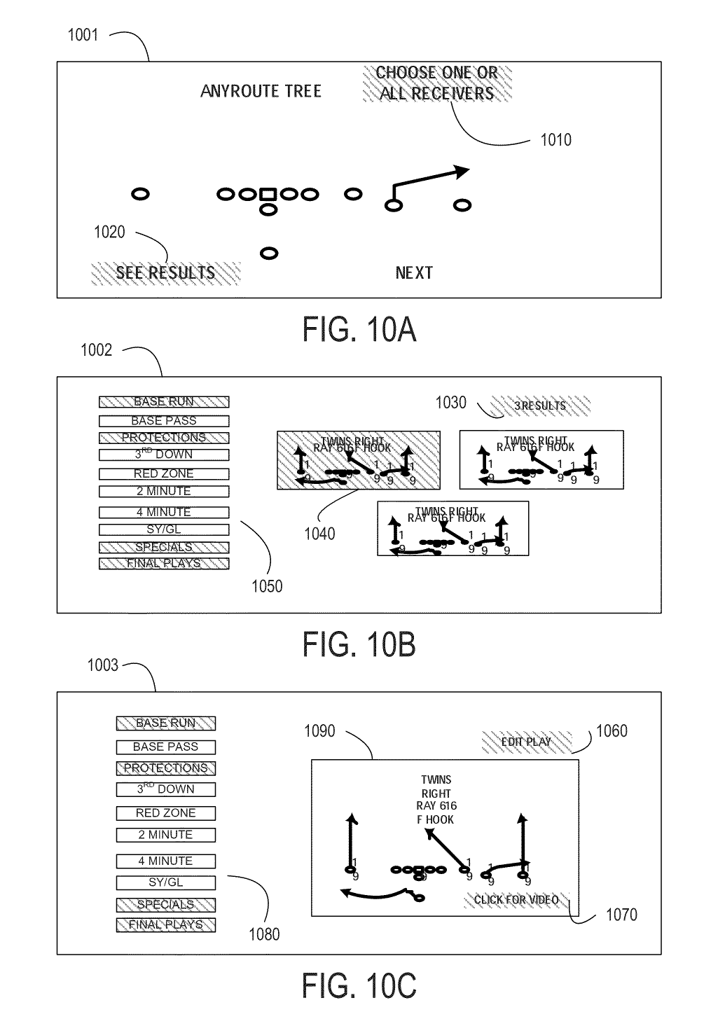

FIG. 10A illustrates an “any route” user interface 1001 through which the user can select one or more plays by indicating the specific routes of one or more eligible receivers. An exemplary implementation of the any route user interface 1001 may include all or substantially all of the features described above with respect to FIG. 5A, FIG. 5B, and FIG. 5C. The user interface 1001 illustrated in FIG. 10A includes a button or control 1010 to choose patterns for one or more eligible receivers and a results button or control 1020 to view the plays associated with a user's any route selections.

FIG. 10B illustrates user interface 1002 depicting results obtained in response to the user inputs provided with the user interfaces depicted in FIG. 8A, FIG. 8B, FIG. 8C, FIG. 9A, FIG. 9B, FIG. 9C, and FIG. 10A as described previously. The user interface 1002 illustrated in FIG. 10B includes an indication 1030 of the number of plays that match the selection criteria corresponding to the previously provided user inputs. The user interface 1002 illustrated in FIG. 10B also includes a depiction 1040 of the one or more plays that the selection criteria identified. In some embodiments, the result might include multiple plays having very small differences between or among them. In these embodiments, depicting highly similar plays as part of a multiple play result may be preferable to requiring the user to input every last detail regarding the play under consideration. For example, if two or more plays have substantially the same formation and other parameters, but may have a slightly different pre-snap motion, all such plays might be included in a result rather than requiring the user to identify the pre-snap motion as part of the selection process. Although the depiction 1040 of the three plays in FIG. 10B depicts three instances of the same play, the drawing is illustrative of the concept and, generally, multiple plays presented in user interface 1002 will include perceptible, if small, differences. The user interface 1002 illustrated in FIG. 10B also includes a summary indication of the user's selections 1050.

FIG. 10C illustrates a final selection user interface 1003 generated in response to user input provided to user interface 1002. Referring back to FIG. 10B, the individual play selected by the user is indicated with hashing in the summary indication of the user's selections 1080 and it is this play 1090 that is illustrated in user interface 1003 of FIG. 10C. The user interface 1003 depicted in FIG. 10C also includes an edit play option 1060 and a click for video option 1070. User selection of the edit play option 1060 transitions the user to a new search or to another home page depending upon the implementation. Click for video option 1070 may be implemented in conjunction with the tagging of video described previously such that selection of the option will upload or otherwise access portions of a video database that have been tagged with information sufficient to identify the video as being relevant to the same play that the user selected through the application. Click for video option 1070 might, for example, open a video presentation application and initiate a database query sufficient to identifying portions of the video matching the selected play or plays. Depending upon the implementation, access to the video may be protected with a logon or other form of user authorization mechanism and the video may be presented thorough a different application or through a different display device.

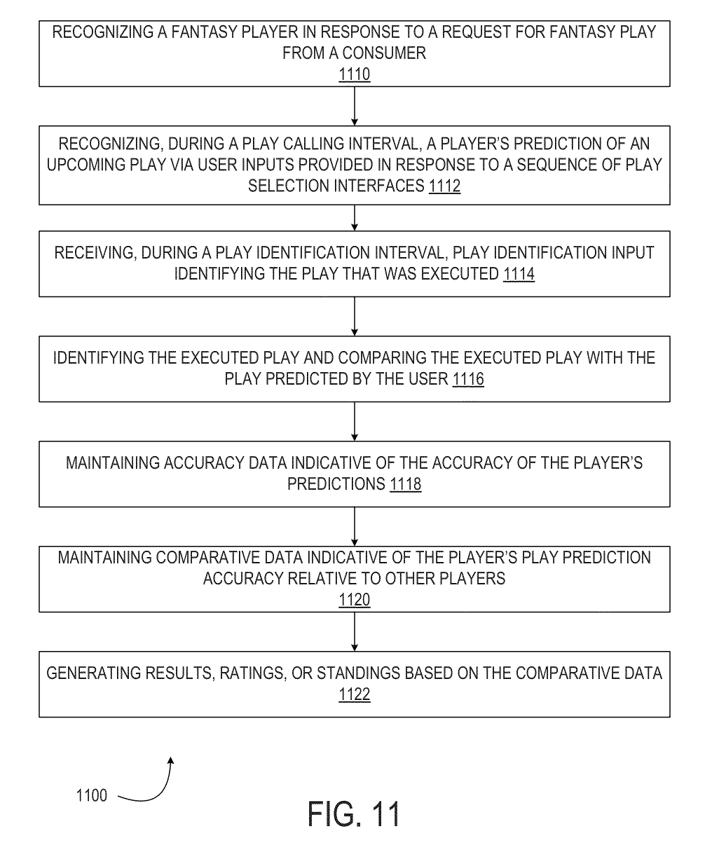

Now turning to FIG. 11, a method 1100 of implementing a vicarious or fantasy football competition is illustrated. In some embodiments, method 1100 invokes or leverages the play selection functionality described previously and extends and streamlines the play selection process to accommodate users, including casual observers as well as more dedicated fans, who may lack the extensive expertise and preparation that coaches and players have, but nevertheless possess a desire to become more involved with the game. In at least one embodiment, users predict upcoming plays by making intuitive choices via one or more user interfaces that illustrate plays visually, thus enabling users to make meaning and intuitive play selection choices even if they do possess an extensive football vocabulary. In at least one embodiment, the user interfaces that are provided to the user are optimized or customized for the specific team that is playing based on the team's previous performance and play calling history. In at least one embodiment, user interfaces are optimized for specific teams through a statistical analysis of the team's play call. For example, the user interfaces for a team that never or rarely executes plays from a specific formation, e.g., shotgun formation, may omit shotgun formations from a formation selection user interface whereas a team that frequently runs plays from the shotgun formation may include one or more shotgun formations as part of a formation selection user interface.

Many fantasy sports organizations and services distinguish success or failure of the teams involved in actual competition and the success or failure of a player. For example, fantasy football and baseball leagues and services are often based on fantasy teams having rosters that are independent of the rosters of the teams from which players are drawn. This leads to a potentially undesirable consequence that participation in a fantasy league actually lessens the player's dedication to a particular team. If, for example, a fantasy football player has drafted the quarterback from a team who is playing the team the fantasy player has selected as its defense, the player has an inherent conflict of interest in terms of who the player supports. Moreover, if the fantasy football player, by design or otherwise, drafts no players from a team that the player would generally identify as his or her favored or preferred team, the player's allegiance to the team may be unintentionally diminished wherein favoring only or primarily those players and teams that benefit the fantasy player's standing in the league or service. The method 1100 illustrated encompasses embodiments that can align the user's interests more closely with the player's team of choice. In addition, whereas many fantasy applications and services require pre-game preparation through the use of weekly or periodic drafts and other activities, embodiments of the illustrated method offer the consumer the opportunity to participate with little or no prior preparation.

As suggested in the preceding paragraphs, method 1100 may access or otherwise leverage the play selection technology described above with respect to playbook database 102 and/or playbook application 232 (see, e.g., FIG. 1 and FIG. 2). In some implementations, method 1100 includes operations performed by a Web server or other network accessible application server as the server executes processor executable program instructions stored in a memory or other computer readable storage of, or accessible to, the server.

In FIG. 11, the operations of method 1100 include recognizing (operation 1110) a fantasy player in response to a request for fantasy play from a user. Generally, method 1100 will be applicable to a large audience of potential users including, as an example, those attending the game or watching a broadcast of the game from home or elsewhere. In some embodiments, users access one or more application servers performing method 1100 through a Web browser or a dedicated Web application. In the case of a dedicated Web application, the application may be implemented as part of a football playbook application 232 (FIG. 2) stored in a memory 230 of a user's mobile device 202 or other computer system and executed by a processor 204. Regardless of whether the consumer accesses the application server from a general purpose Web browser or a dedicated application, the application server may present the user via various interfaces and including various links or other selectable objects for providing user input. A user interface may, for example, include a “join game” object enabling the user to submit a request to join a game. Joining a game may include identifying a particular football game being played as well as identifying a group of users against whom the user wants to compete. The group of users may be a group defined by the users themselves including, as an example, a group of users that are organized as a league or other subset of users defining a group of users within which rankings, standings, or another form of comparative scores are determined.

After a user's request to be recognized is processed, the method 1100 illustrated in FIG. 11 includes a sequence that is repeated throughout the game involving a prediction by the one or more users regarding an upcoming play, usually the next play, a determination or identification of the play after it is executed, and a comparison between the play predicted by the user and the play identified. The comparison determines the extent to which the user's prediction of the play matches the subsequent identification of the play and is an indicator of the accuracy of the user's prediction. Data indicative of the user's accuracy on each of one or more plays is accumulated and may be used to rank the various users in a league or other group of users.

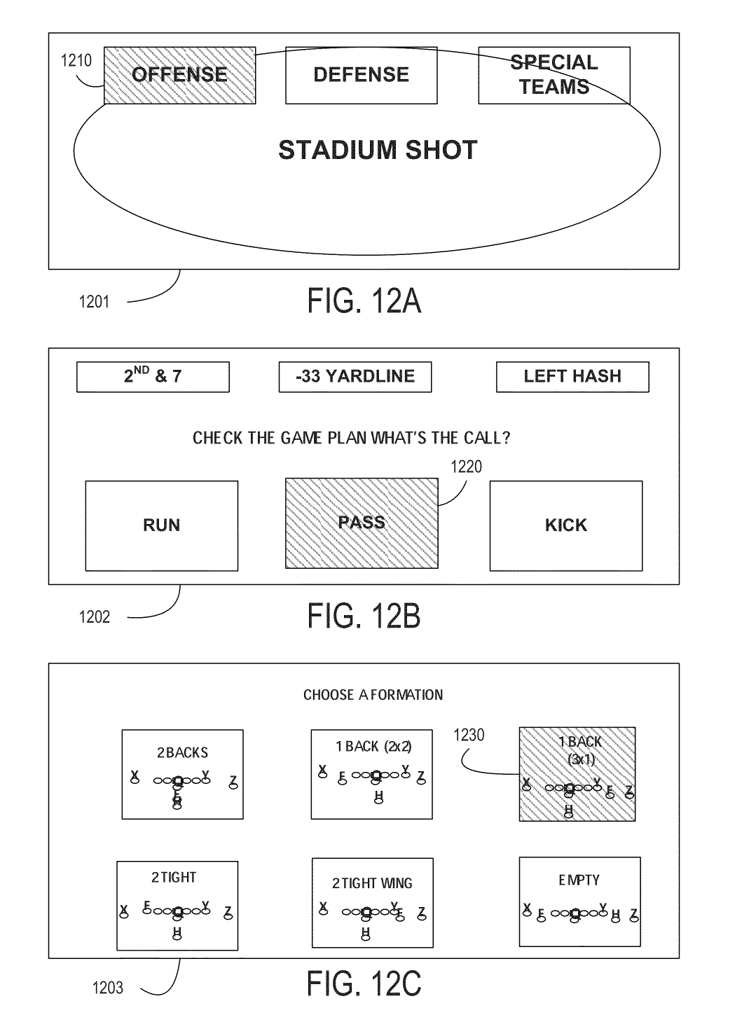

Method 1100 as illustrated in FIG. 11 implements the basic sequence described in the preceding paragraph with server application operations that recognize, during a play calling interval, a player's prediction of an upcoming play via user inputs (operation 1112) and receive (operation 1114) during a play calling interval. The play calling interval during which user predictions are recognized may coincide with the interval between the end of the previous play, usually signaled by a referee's whistle and the beginning of the next play, usually initiated by the snap of the football by the center. The user's prediction of an upcoming play may be indicated by a sequence of user inputs provided in response to a sequence of play selection user interfaces having features in a manner analogous to or substantially similar to the series or sequence of user interfaces described above with respect to FIGS. 4 through FIGS. 6 and FIGS. 8 through FIGS. 10. The play selection user interfaces provided as part of a fantasy application may be streamlined or otherwise simplified with respect to the user interfaces provided to coaches and players as described previously. For example, whereas the play selection user interfaces provided to coaches and players may include substantially every play in a playbook database and may require the user to select a value for a large number of play selection parameters, the fantasy application may employ an edited subset of the available plays and may require the user to provide inputs to fewer play selection parameters as will be illustrated with respect to FIG. 12 through FIG. 14.

Method 1100 may include, as illustrated in FIG. 11, identifying plays after they are executed and comparing executed plays with the plays predicted by the users (operation 1116). Identification of executed plays may be implemented with live “spotters” at the game. In this approach, one or more spotters skilled in the identification of football plays may use a play identification application that is functionally similar to the play selection application used by the players. As or shortly after a play is executed, the one or more spotters would provide inputs to identify the play and the identified play would then become the play against which all predicted plays are compared. In another embodiment, one or more stationary or movable cameras positioned above the field of play may be used to monitor the initial formation of the players before a play begins as well as the motion paths of the various players as the play is executed. The images provided by these one or more cameras may be analyzed with pattern recognition techniques to identify a match between the executed play and a play from the playbook database. In still another embodiment, the players on the field may be equipped with electronic transmitting devices that convey the position of the player during a play. The information provided by these transmitting devices may be detected and processed by a receiver and analyzed by a suitable application to determine a match between the executed play and a play in the playbook.

The method 1100 illustrated in FIG. 11 further includes maintaining (operation 1118) accuracy data indicative of the accuracy of the player's predictions and maintaining (operation 1120) comparative data indicative of the player's play prediction accuracy relative to other players. Results, ratings, or standings may then be generated (operation 1122) based on the comparative data. Various alternatives to the method illustrated may be included.

Referring now to FIG. 12A, a user interface 1201 suitable for use in conjunction with method 1100 described is illustrated. The illustrated embodiment of user interface 1201 prompts the user to select among offense, defense, and special teams plays and includes corresponding selectable icons. The user interface 1201 illustrated in FIG. 12 includes highlighting of the offense icon 1210 to indicate that the user selected offense icon 1210. In some embodiments, user interface 1201 may be omitted. For example, in some embodiments, the user may declare or associate with one of the two teams that are playing a particular game. When the user's declared team is on offense, the application may automatically determine that the team is on offense, e.g., through information provided from the game by a spotter or other mechanism, and automatically provide the user with offensive plays while the user's declared team is in possession of the ball. Similarly, down and clock information may be provided to a server and the server may be programmed to automatically provide the user with the option of selecting a special teams play on fourth down plays or when there is little or no time left on the play clock before halftime or at the end of game.

FIG. 12B illustrates a type-of-play user interface 1202 generated when the user indicates offense in response to first user interface 1201. Type-of-play user interface 1202 prompts the user to indicate a run, pass, or kick play with selectable icons including the pass icon 1220 that is illustrated with highlighting to indicate that the user has selected pass as the type of play. The user interface 1202 illustrated in FIG. 12B also includes informational data including a down and distance indicator, a yard line indicator, and a hash mark indicator to indicate where the line of scrimmage and ball will be at the start of the next play and what the down and distance will be as well.

FIG. 12C illustrates a formation user interface 1203 generated in response to user selection of pass icon 1220 from type-of-play user interface 1202. Formation interface 1203 as illustrated in FIG. 12C prompts the user to select one of a number of play formations represented by individual icons as shown. In some embodiments, the formation interface presents the user with a subset of all play formations to keep the application manageable and easy to use for fantasy type applications. For example, the formations presented in FIG. 12C may be streamlined by the play selection server based on the team that has the ball, the down and distance, the score of the game, other suitable factors, or a combination thereof. Thus, for example, the formations presented may represent the formations that the particular team uses most often based on historical information. Similarly, the formations included in user interface 1203 may be filtered based on the players on the field. If, for example, a team runs a two quarterback offense or some variant of a two quarterback offense, the formations presented in formation user interface 1203 may change if the play selection server receives information indicating that the second quarterback has entered the lineup. Similarly, the formations presented may be influenced by down and distance, time left in game, score of game, and so forth. In some embodiments, the formation selection interface 1203 includes the fewest number of formations possible to cover some specified percentage of the formations used by the applicable team historically under similar game circumstances. For example, the formation user interface 1203 might include the fewest number of formations required to cover 80% of all formations used by the applicable team in similar game circumstances, i.e., similar down, distance, time on clock, score, and the like. Thus, whereas a play selection application optimized for a coach or player preparing or studying a game plan may present the player or coach with a large number of formations, the formation interface 1203 illustrated in FIG. 12C is optimized for the home/consumer user in a fantasy application or the like. User interface 1203 is illustrated in FIG. 12C with a “1 Back (3×1)” formation icon 1230 selected.

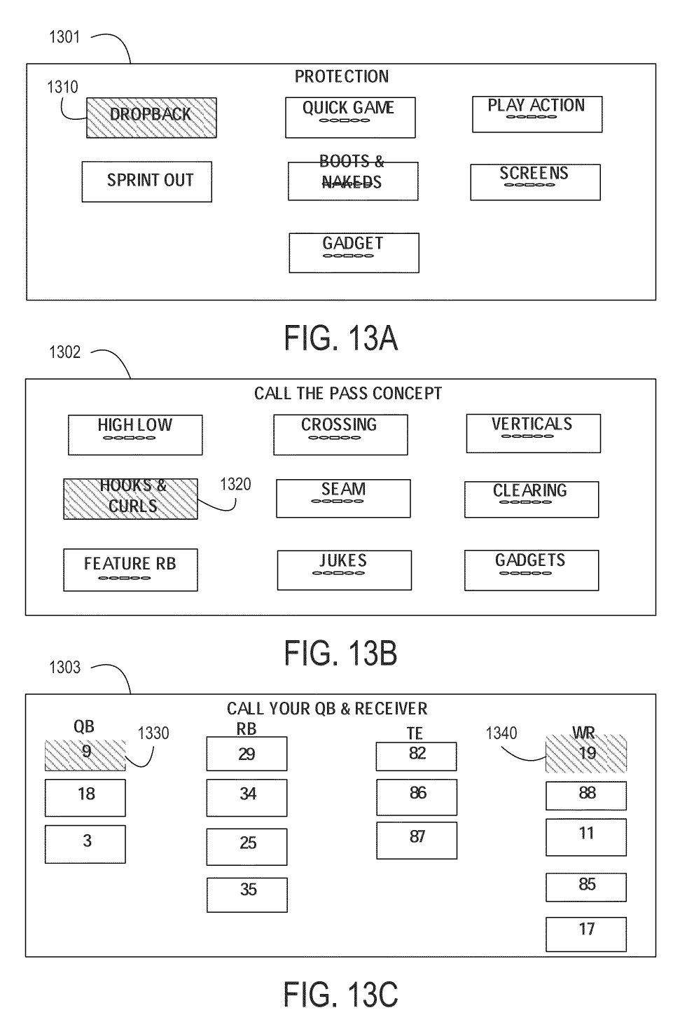

Turning now to FIGS. 13A, 13B, and 13C, additional user interfaces 1301, 1302, and 1303 are illustrated. User interface 1301 illustrated in FIG. 13A prompts the user to select a protection scheme in the case of a pass play Like formation user interface 1203 described above with respect to FIG. 12C, the selectable icons presented in conjunction with protection user interface 1301 may include a subset of all protections that the applicable team may employ out of a given formation. Again, the subset of protections presented to the user may include the protections most frequently used by the applicable team in similar game circumstances. The protection user interface 1301 illustrated in FIG. 13A indicates a drop back protection icon 1310 as being highlighted to indicate that the user selected this icon as the protection scheme selected. In some embodiments, one or more user interfaces may be omitted from the play selection to streamline and simplify the play selection process even further. Moreover, which user interfaces to include or exclude from the play selection process may, itself, be a user selectable option, either statically or dynamically. In other embodiments, certain application settings may be determined by an administrator of the group of users that participate in a common league. For example, a user may be designated as a commissioner of a particular league and the commissioner may have access to and authorization to change settings controlling predetermined aspects of the play selection application. In these embodiments, the league commissioner may control, as examples, the number of user interfaces provided to a user on offense, the number of user interfaces provided to a user on defense, and so forth. Similarly, the league commissioner may have control of the maximum and/or minimum number of icons presented to a user with any given interface.

FIG. 13B illustrates a pass concept user interface 1302 prompting the user to select a pass concept after selecting a particular protection scheme in user interface 1310. For example, because the user selected drop back interface 1310 in FIG. 13A, the pass concept icons depicted in pass concept user interface 1302 are pass concepts that are or can be executed with drop back protection. The user interface 1302 illustrated in FIG. 13B indicates a hooks and curls icon 1320 as being selected by the user.

FIG. 13C illustrates an options user interface that prompts the user to select specific individuals from the applicable team for certain positions. The user interface 1303 illustrated in FIG. 13C, for example, prompts the user to select a quarterback, a running back, a tight end, and a wide receiver. The illustrated user interface indicates user selection of a player wearing the number “9” as the quarterback and the player wearing number “19” as the wide receiver. In some embodiments, the user may indicate default selections for one or more of the positions represented in user interface 1303. For example, a user may indicate the starting quarterback as the default quarterback for all plays on offense when the applicable team rarely substitutes the starting quarterback. The user interface 1303 illustrated in FIG. 13C indicates a “QB” icon 1330 and a “WR” icon 1340 as being selected by the user.

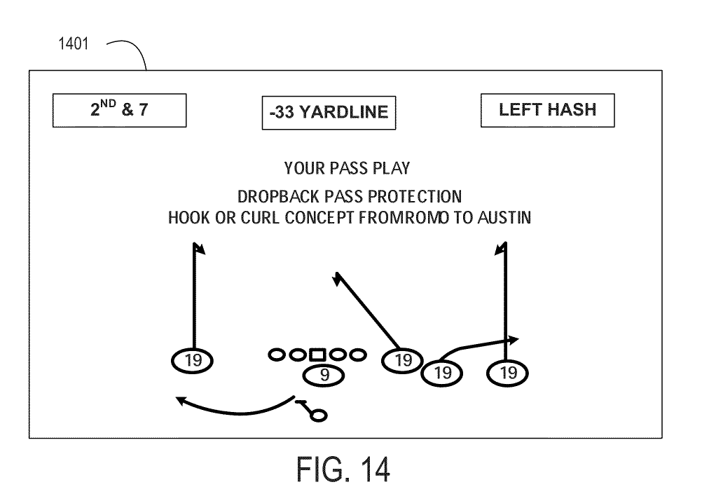

Turning now to FIG. 14, a selected-play user interface 1401 presents the user with the play the user selected via the user input provided in response to the user interfaces described above with respect to FIGS. 12A, 12B, 12C, 13A, 13B, and 13C. The selected-play user interface 1401 illustrated in FIG. 14A includes information indicating down and distance, line of scrimmage, and a hash mark indication. Some embodiments may include a game clock, scoreboard, or other formation or additional information while other embodiments may include less information. The illustrated embodiment of selected-play user interface 1401 includes the number of specified individual players, usually the players most likely to handle the ball on offense and the players most likely to defend the players most likely to handle the ball on defense, e.g., a wide receiver on offense and a defensive back covering the wide receiver on defense.

The selected-play user interface 1401 depicted in FIG. 14 does not depict a formation or play for the “other” team, the defense in the case of FIG. 14. At least one embodiment of the play selection applications described above with respect to FIG. 11 (fantasy application) and FIG. 3 (coach/player application) may generate multiple icons after receiving all user inputs where the multiple icons represent the play selected by the user versus a number of formations that the opposing team may line up in. For example, if the user is on offense selecting a run play, the play selection application may provide the user with a plurality of images after determining which play the user has selected. In this example, the different images illustrate different defensive schemes the defense might line up in and may indicate to the offense different blocking schemes for each different defense illustrated. Similarly, if the user is on offense and selected a pass play, the application may present the user with a number of images representing different defensive formations and pass rush options with the different pass protection assignments applicable to each depicted defensive formation/pass rush permutation. In the context of the coach/player application of FIG. 3, depicting all of the defensive formations and corresponding blocking assignments beneficially simplifies the task of constructing the portion of a playbook associated with the particular play by automatically enumerating some or all of the defenses that a team might expect to see in connection with a particular play and how the assignment of individual offensive players may change depending upon the defense. With respect to the fantasy application illustrated with respect to FIG. 11, it may be optional to present the defenses associated with a particular play while some embodiments may permit the offensive user to indicate a predicted defense as well depending upon how much time the player has between plays. If a team is executing a hurry-up, no-huddle, or other portion of the playbook designed to reduce the amount of time spent in play calling huddles, the user may lack sufficient time to make a defensive selection.

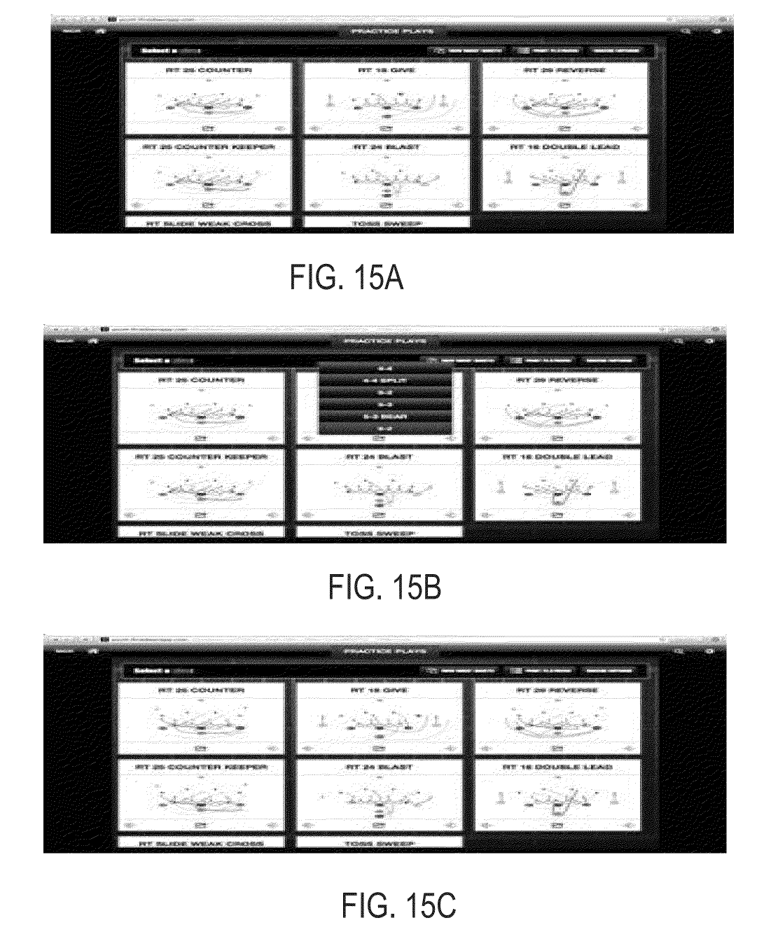

In some embodiments, a default defense is illustrated after a play selection process is completed and the user interface enables the user to select a different defense. Similarly, a collection of plays (e.g., all plays selected for a particular game or game plan) may be illustrated with respect to a default or specified defense while enabling the user to select a different defense for each of the one or more plays indicated. FIG. 15A illustrates an example user interface illustrating a collection of plays selected for a given game or game plan including block assignments for a specified defense. FIG. 15B illustrates a defensive play selection drop down menu enabling the user to identify a different defense for each of the applicable plays and FIG. 15C illustrates the same set of offensive plays illustrated in FIG. 15A with block assignments modified for the defense illustrated in FIG. 15C.

Thus, it will be appreciated from all of the above that the disclosed subject matter encompasses a play selection method, server, and media that includes presenting a sequence of play selection interfaces to a user, wherein at least some of the play selection interfaces include a plurality of diagrams, receiving user inputs selecting one of the diagrams from each of the play selection interfaces, and determining a selected play, based on the user inputs, from a plurality of plays in a play database. The play database may associated with a team and the plurality of diagrams included in a play selection interface may be selected based on historical play information indicative of plays executed by the team. At least some of the play selection interfaces may be associated with a corresponding play characteristic. In at least one embodiment, the play selection interfaces include an offense/defense interface, a run/pass/kick interface, a formation interface, a protection interface, a route concept interface, and a game situation interface. In the context of a fantasy football application, the method may further include receiving, during a play identification interval after execution of the play, play identification input indicative of an executed play and comparing the selected play to the executed play to determine an accuracy of the predicted play. The method may still further include maintaining accuracy data indicative of the accuracy of a plurality of predicted plays associated with the user over a predetermined interval, maintaining comparative data indicative of the accuracy of the user relative to other users in a predetermined group of users. In the context of a coach/player game plan application, the method may include accessing, based on the selected play, selected video in a video database wherein the selected video comprises video of the selected play.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A play selection method, comprising:
presenting a sequence of play selection interfaces to a user, wherein at least some of the play selection interfaces include a plurality of diagrams;
receiving user inputs selecting one of the diagrams from each of the play selection interfaces; and
determining a selected play, based on the user inputs, from a plurality of plays in a play database.

2. The method of claim 1, wherein the play database is associated with a team and wherein the plurality of diagrams included in a play selection interface are selected based on historical play information indicative of plays executed by the team.

3. The method of claim 1, wherein at least some of the play selection interfaces are associated with a corresponding play characteristic.

4. The method of claim 3, wherein the play selection interfaces include an interface selected from: an offense/defense interface, a run/pass/kick interface, a formation interface, a protection interface, a route concept interface, and a game situation interface.

5. The method of claim 1, further comprising:
receiving, during a play identification interval after execution of the play, play identification input indicative of an executed play; and
comparing the selected play to the executed play to determine an accuracy of the predicted play.

6. The method of claim 5. further comprising:
maintaining accuracy data indicative of the accuracy of a plurality of predicted plays associated with the user over a predetermined interval.

7. The method of claim 6, further comprising:
maintaining comparative data indicative of the accuracy of the user relative to other users in a predetermined group of users.

8. The method of claim 1, further comprising accessing, based on the selected play, selected video in a video database.

9. The method of claim 8, wherein the selected video comprises video of the selected play.

10. A application server, comprising:
a processor;
computer readable storage including processor executable program instructions that cause to processor to perform operations, comprising:
presenting a sequence of play selection interfaces to a user, wherein at least some of the play selection interfaces include a plurality of diagrams;
receiving user inputs selecting one of the diagrams from each of the play selection interfaces; and
determining a selected play, based on the user inputs, from a plurality of plays in a play database.

11. The application server of claim 10, wherein the play database is associated with a team and wherein the plurality of diagrams included in a play selection interface are selected based on historical play information indicative of plays executed by the team.

12. The application server of claim 10, wherein at least some of the play selection interfaces are associated with a corresponding play characteristic.

13. The application server of claim 3, wherein the play selection interfaces include an interface selected from: an offense/defense interface, a run/pass/kick interface, a formation interface, a protection interface, a route concept interface, and a game situation interface.

14. The application server of claim 10, wherein the operations include:
receiving, during a play identification interval after execution of the play, play identification input indicative of an executed play; and
comparing the selected play to the executed play to determine an accuracy of the predicted play.

15. The application server of claim 14, wherein the operations include:
maintaining accuracy data indicative of the accuracy of a plurality of predicted plays associated with the user over a predetermined interval.

16. The application server of claim 15, wherein the operations include:
maintaining comparative data indicative of the accuracy of the user relative to other users in a predetermined group of users.

17. The application server of claim 16, wherein the operations include:
generating at least one of: results, ratings, standings for the group of users based on the comparative data.

18. The application server of claim 10, wherein the operations include accessing, based on the selected play, selected video in a video database.

19. The application server of claim 18, wherein the selected video comprises video of the selected play.

20. Non-transitory computer readable memory media, the memory media storing executable instructions, the instructions including instructions to:
receive user input indicating a search criteria, wherein the search criteria specifies at least one of: a formation and a position-route;
retrieve, from a database, plays matching the search criteria; and
enable a user to select the plays matching the search criteria.
